(19) United States
(12) Patent Application Publication
(10) Pub. No.: US 2020/0173332 A1
(43) Pub. Date: Jun. 4, 2020

(54) APPARATUS FOR INTRODUCING AND DISTRIBUTING A FLOWABLE ADDITIVE INTO AN EXHAUST GAS FLOW

(71) Applicant: FRIEDRICH BOYSEN GMBH & CO. KG, ALTENSTEIG (DE)

(72) Inventors: Stefan Sauer, Wildberg (DE); Markus Prokopp, Jettingen (DE); Michael Schleh, Pfalzgrafenweiler (DE); Jürgen Kobe, Nürtingen (DE); Moritz Wied, Tübingen (DE); Matthias Riepshoff, Nagold (DE)

(21) Appl. No.: 16/699,949

(22) Filed: Dec. 2, 2019

(30) Foreign Application Priority Data
Dec. 3, 2018 (DE) 102018130716.0

(51) Int. Cl. F01N 3/20; F01N 13/00; F01N 3/28; B01D 53/94; B01F 3/04; B01F 5/04; B01F 5/00

(52) U.S. Cl. CPC F01N 3/2066; F01N 13/009; F01N 3/2892; F01N 2610/1453; B01F 3/04021; B01F 5/0403; B01F 5/0057; B01D 53/9431

(57) ABSTRACT

An apparatus for introducing and distributing a flowable additive into an exhaust gas flow comprises an inlet to receive the exhaust gas flow from a first exhaust gas treatment device, an outlet to output the exhaust gas flow to a second exhaust gas treatment device, a flow conducting device to lead the exhaust gas flow from the inlet to the outlet, and an injector opening into the flow conducting device, wherein an at least substantially straight-line main flow direction of the apparatus is defined by the inlet and the outlet. A mixing section of the flow conducting device arranged downstream of the injector extends obliquely or transversely to the main flow direction.

The present invention relates to an apparatus for introducing and distributing a flowable additive into an exhaust gas flow comprising an inlet to receive the exhaust gas flow from a first exhaust gas treatment device, an outlet to output the exhaust gas flow to a second exhaust gas treatment device, a flow conducting device to lead the exhaust gas flow from the inlet to the outlet, and an injector opening into the flow conducting device, wherein an at least substantially straight-line main flow direction of the apparatus is defined by the inlet and the outlet.

The exhaust gases of internal combustion engines are generally subjected to a cleaning process or to a plurality of cleaning processes before emission into the atmosphere to limit the environmental impact. Such cleaning processes frequently require the introduction and distribution of liquid additives into the exhaust gas flow. The additives are generally sprayed into the hot exhaust gas flow by means of the injector. It is, for example, known for the reduction of nitrogen oxides in the exhaust gas of diesel engines to carry out a selective catalytic reduction (SCR) that is carried out in a so-called SCR catalytic converter using a reductant. An aqueous urea solution can specifically be injected into the exhaust gas. The urea degrades in the exhaust gas to ammonia that reacts with the nitrogen oxides of the exhaust gas.

It is important in the sense of an effective exhaust gas treatment that the additive is mixed as uniformly as possible with the exhaust gas and is converted as completely as possible into the gaseous phase. This can be ensured by a sufficiently long mixing distance having a correspondingly long dwell time. It is, however, often difficult in practice due to construction space restrictions to provide long mixing distances with an acceptable pressure loss. This problem is particularly pronounced with SCR systems close to the engine since the space conditions in the engine space are particularly tight.

It is an object of the invention to provide an apparatus for introducing and distributing a flowable additive into an exhaust gas flow that is compact, only causes a relatively low pressure loss, and nevertheless enables an effective mixture and evaporation of the additive.

The object is satisfied by an apparatus having the features of claim 1.

The invention provides that a mixing section of the flow conducting device arranged downstream of the injector extends obliquely or transversely to the main flow direction. The flow conducting device therefore does not lead the exhaust gas flow with the introduced additive directly to the outlet, but via a bypass. The mixing distance is thereby increased and the dwell time of the additive is greater. An effective mixing and evaporation of the injected additive is thus made possible that results from the generally straight-line main flow direction despite the space saving design.

The mixing section does not necessarily have to extend in a straight line. An at least partly curved mixing element can also extend obliquely or transversely to the main flow direction on an section-wise observation.

Further developments of the invention can be seen from the dependent claims, from the description, and from the enclosed drawings.

The inlet and the outlet can have respective passage surfaces that extend at least substantially in parallel with one another and/or that at least regionally overlap in the main flow direction. An apparatus of such a design is particularly compact and can be installed close to the engine. The inlet and the outlet can in particular be arranged at least substantially coaxially with respect to the main flow direction. The inlet and the outlet are preferably configured for a direct connection to the exhaust gas treatment devices or to its housing. The inlet and the outlet can have corresponding attachment flanges for this purpose. The apparatus is preferably configured such that the total exhaust gas flow exiting the first exhaust treatment device moves into the inlet and/or the total exhaust gas flow exiting the outlet moves into the second exhaust treatment device.

An embodiment of the invention provides that the mixing section extends in an angular range between 30° and 150°, preferably between 60° and 120°, particularly preferably between 70° and 100°, with respect to the main flow direction. The mixing section can in particular extend at a right angle to the main flow direction. A particularly pronounced extension of the mixing distance thereby results. The mixing section is preferably of a pipe kind or of a passage kind. An extent in a specific angular range as indicated above means in this embodiment that the position of the pipe axis or passage axis has an angle to the main flow direction that is within the respective range. In the case of a curved mixing section, all the locally definable pipe axes or passage axes are disposed within the respective range.

In accordance with a special embodiment of the invention, the flow introduction device has a deflection section arranged upstream of the mixing section to deflect the exhaust gas flow and/or to generate an eddy of the exhaust gas flow in the mixing section. The deflection section can form the transition of an intake section of the flow conducting device aligned with the inlet to the mixing section. An eddy of the exhaust gas flow improves the distribution and evaporation of the additive.

Provision can be made that the mixing section extends, viewed in the main flow direction, from a first radial outer region of the inlet up to an opposite second radial outer region of the inlet. This means that the mixing section can extend, on an axial observation, at least once transversely beyond the inlet, whereby a pronounced extension of the mixing distance is made possible.

The invention also relates to an apparatus for introducing and distributing a flowable additive into an exhaust gas flow, in particular as described above, comprising an inlet to receive the exhaust gas flow from a first exhaust gas treatment device, an outlet to output the exhaust gas flow to a second exhaust gas treatment device, a flow conducting device to lead the exhaust gas flow from the inlet to the outlet, and an injector opening into the flow conducting device, wherein an at least substantially straight-line main flow direction of the apparatus is defined by the inlet and the outlet, and wherein a mixing section of the flow conducting device is arranged downstream of the injector.

Provision is made in accordance with the invention here that the flow conducting device defines a first flow path comprising the mixing section for a first part flow of the exhaust gas flow and a separate flow path for a second part flow of the exhaust gas flow, wherein the first and second flow paths are arranged in parallel with one another in a technical flow aspect. An advantage of this configuration is that a portion of the exhaust gas flow can be led on a different path, e.g. a shorter path in the sense of a reduced pressure drop, to the outlet than is predefined by the mixing section. The term “parallel” is here to be understood in the abstract in the sense of a parallel connection and not, for instance, in the geometrically strict sense. This means that the actual flows in the two flow paths can in principle extend obliquely, transversely, or oppositely to one another.

This idea of the invention and the one described in the introduction can be advantageously combined as required.

In accordance with an embodiment of the invention, the injector opens into the first flow path, in particular into an upstream entry section of the first flow path. This means that is preferred that the injector is configured for spraying the additive into that flow path that extends at least sectionally obliquely or transversely to the main flow direction. An effective mixing of the additive can take place in the extended flow path.

The second flow path is preferably configured for a larger part flow than the first flow path. Embodiment have proved to be particularly favorable in which the second flow path is configured for a mass flow of at least 70% and at most 99%, particularly of at least 80% and at most 99%, particularly preferably of at least 90% and at most 97%, of the total mass flow.

The second flow path can comprise a swirl generating section that generates a swirl, in particular a double swirl, in the respective part flow during operation of the apparatus due to its shape. On a merging of the first and second flow paths, the premixed part flow coming from the injector is particularly effectively mixed with the other part flow due to the swirl.

The swirl generating section is preferably configured for generating at least one swirl whose swirl axis is arranged obliquely or transversely, preferably at least substantially at a right angle, to the main flow direction. Such a swirl can be relatively easily generated by a corresponding shape of the walls.

The swirl generating section can in particular have at least one curved wall section, preferably two oppositely disposed and respectively outwardly curved wall sections. A swirl generating flow deflection occurs on an impact of the exhaust gas flow on the curved wall section. Two oppositely disposed and respectively outwardly curved wall sections generate a double swirl in a simple manner.

The mixing section can open into a deflection chamber that deflects the part flow exiting the mixing section and supplies it to a gas exit passage that is in flow communication with the swirl generating section. The deflection chamber can generate a further eddy and thus improve the mixing. In addition, the hot surfaces of the deflection chamber can promote the evaporation of the additive.

It is also possible that the deflection chamber effects an at least substantially U-shaped deflection and/or that the mixing section and the gas exit passage extend at least substantially in opposite directions. The expression “in opposite directions” is here to be understood in a technical flow aspect and not in a geometrically strict sense. The mixing section and the gas exit passage can in particular each at least substantially extend once through the total flow conducting device. An arrangement formed by the mixing section, the deflection chamber, and the gas exit passage can have an approximately U shape overall.

In accordance with a special embodiment of the invention the gas exit passage is at least in flow communication with the swirl generating section through an exit opening, in particular an elongate exit opening. A good distribution of the part flow containing the additive can take place in the swirl region by the supply of the premixed part flow into the swirl generating section. The gas exit passage can also have one or more exit sections having at least one exit opening. Provision can furthermore be made that an elongate exit opening extends at least substantially once through the total flow conducting device.

A further embodiment of the invention provides that a guide element is arranged in the swirl generating section and deflects exhaust gas passing through the exit opening in the direction of a wall of the swirl generating section. This promotes the forming of a swirl or double swirl in the swirl generating section. It can in particular screen the swirl region from a direct onflow. The guide element is preferably configured as a simple (single-piece or multi-piece) sheet metal component.

A specific embodiment of the invention provides that the guide element has a U-shaped or V-shaped cross-section or a combination thereof. The guide element is preferably sectionally curved viewed in cross-section. This has proved to be particularly favorable for the assistance of the swirl formation.

The mixing section can be at least sectionally led around the swirl generating section. A more particularly compact construction thereby results. In addition, in this embodiment, a pronounced transfer of thermal energy that supports the evaporation takes place from the swirl generating section to the mixing section.

In accordance with a further embodiment of the invention, the swirl generating section has an intake whose intake surface extends at least substantially in parallel with a passage surface of the inlet and/or the swirl generating section has an egress whose egress surface extends at least substantially obliquely, in particular perpendicular, to a passage surface of the outlet. It is particularly preferred for a space saving design that the swirl generating section directly adjoins the inlet.

The swirl generating section can have an egress that is arranged such that exhaust gas exiting it acts on at least one section of the first flow path. Thermal energy that increases the evaporation performance is thereby supplied to the first flow path. The egress of the swirl generating section can in particular be arranged such that an injection region of the first flow path is acted on. A cooling of the first flow path by incident spray can thereby be countered.

In accordance with a further embodiment of the invention the swirl generating section has an egress that is arranged such that exhaust gas exiting it is deflected by at least 20°, preferably by at least 30°, before reaching the outlet. The eddying is hereby further improved. In addition, the mixing distance is additionally extended.

The present invention also relates to an exhaust system having a first exhaust gas treatment device, in particular an oxidation catalyst, a second exhaust gas treatment device, in particular a reduction catalytic converter, and an apparatus for introducing and distributing a flowable additive into an exhaust gas flow led from the first exhaust gas treatment device to the second exhaust gas treatment device.

The apparatus for introducing and distributing the flowable additive is configured as described above in accordance with the invention and is arranged between the first and second exhaust gas treatment devices. A compact and simultaneously effective SCR system is provided in this manner.

Provision is preferably made that the first exhaust gas treatment device, the second exhaust gas treatment device, and the apparatus for introducing and distributing the flowable additive are integrated in a common, single-piece or multi-piece, housing and/or at least substantially adjoin one another without a step. A particularly compact construction thereby results. A corresponding apparatus can in particular be installed in the engine region of a passenger car.

Provision can be made that an outlet surface of the first exhaust gas treatment device and an inlet surface of the second exhaust gas treatment device extend at least substantially in parallel with one another and/or overlap at least regionally viewed in a straight-line main flow direction. Such a configuration is particularly compact.

The invention will be described in the following by way of example with reference to the schematic (sectional) drawings.

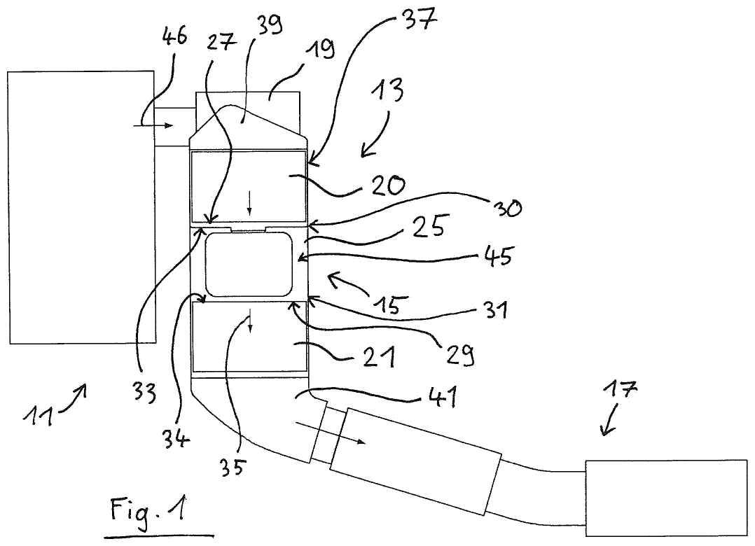

FIG. 1 shows an internal combustion engine having an exhaust system in accordance with the invention in a simplified side view;

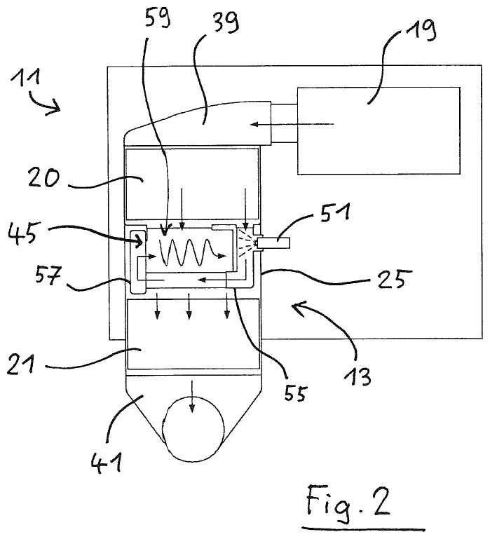

FIG. 2 shows the arrangement in accordance with FIG. 1 from the rear;

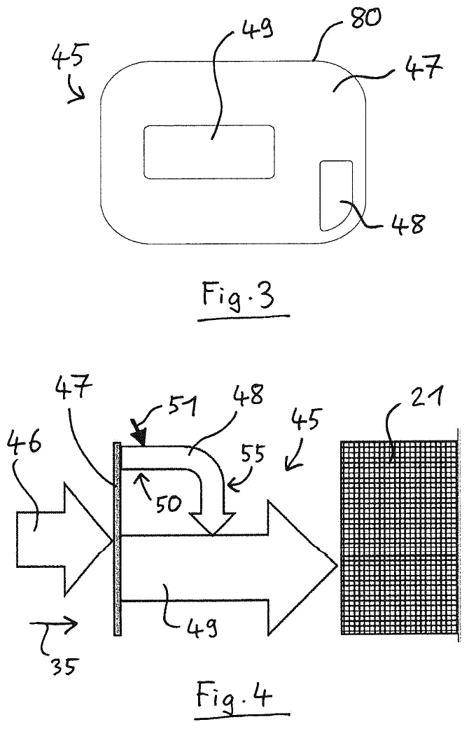

FIG. 3 shows a flow conducting device of the exhaust system shown in FIG. 1 from above;

FIG. 4 schematically shows the flow progression in the flow conducting device in accordance with FIG. 3;

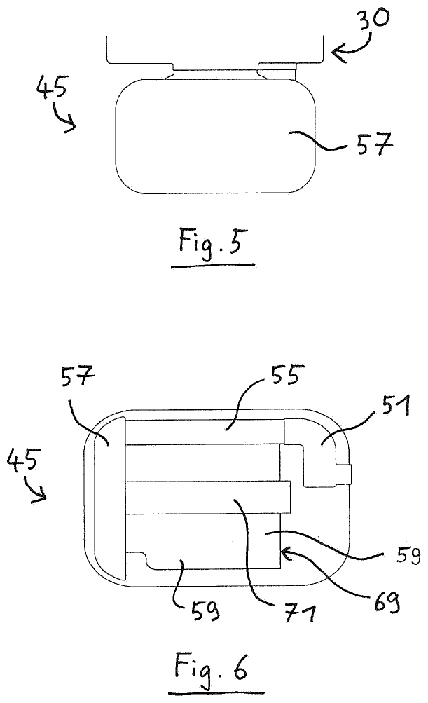

FIG. 5 shows the flow conducting device in accordance with FIG. 3 from the rear;

FIG. 6 shows the flow conducting device in accordance with FIG. 3 from below;

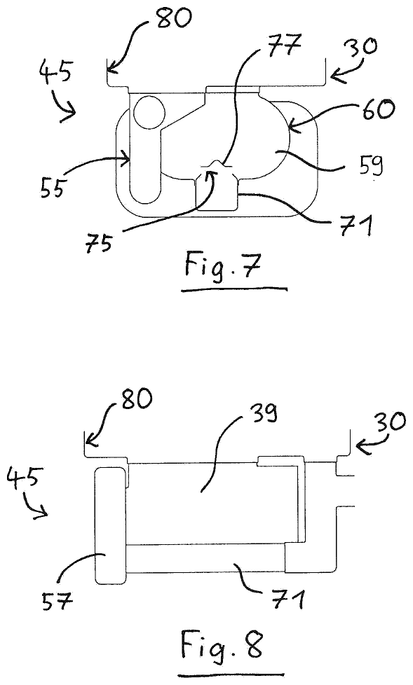

FIG. 7 shows the flow conducting device in accordance with FIG. 3 from the front;

FIG. 8 shows the flow conducting device in accordance with FIG. 3 from the side;

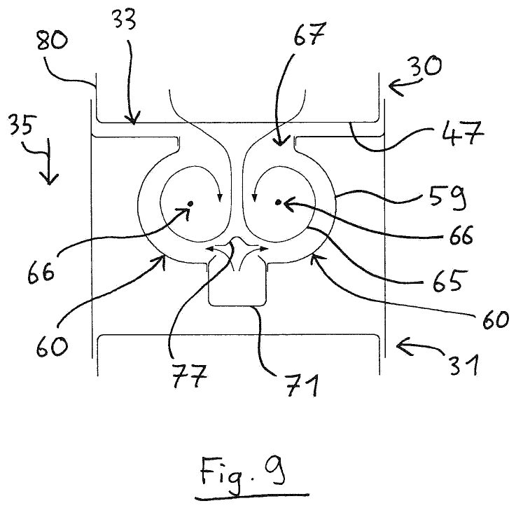

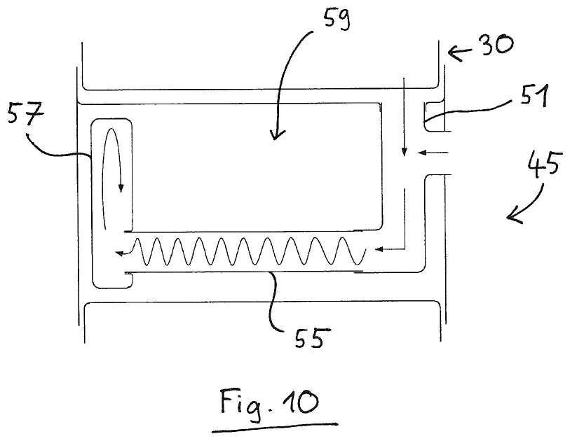

FIG. 9 shows the flow progression in a swirl generating section of the flow conducting device in accordance with FIG. 3;

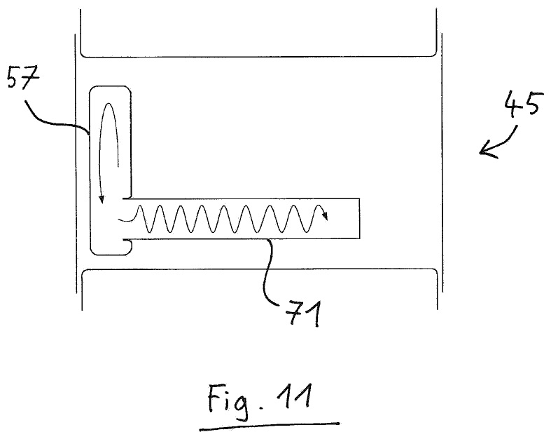

FIG. 10 shows the flow progression in a mixing section of the flow conducting device in accordance with FIG. 3;

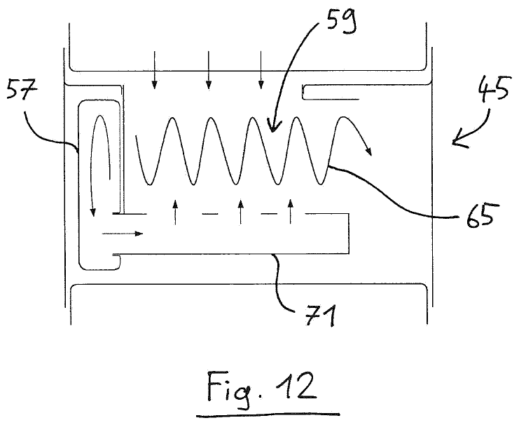

FIG. 11 shows the flow progression in a gas exit passage of the flow conducting device in accordance with FIG. 3; and

FIG. 12 shows a merging of part flows in the flow conducting device in accordance with FIG. 3.

The internal combustion engine 11 show in FIGS. 1 and 2 has an exhaust system 13 in accordance with the invention that here comprises a section 15 close to the engine and an undersurface section 17. The section 15 close to the engine has an exhaust gas turbocharger 19, a first exhaust gas treatment device in the form of an oxidation catalyst 20, and a second exhaust gas treatment device in the form of a reduction catalytic converter 21, in particular an SCR catalytic converter. An apparatus 25 in accordance with the invention for introducing and distributing a flowable reductant into an exhaust gas flow 46 is arranged between the oxidation catalyst 20 and the reduction catalytic converter 21.

As shown, the oxidation catalyst 20, the apparatus 25, and the reduction catalytic converter 21 are arranged at least substantially coaxially to one another. The exit surface 27 of the oxidation catalyst 20 in particular extends at least substantially in parallel with the entry surface 29 of the reduction catalytic converter 21. The apparatus 25 has an inlet 30 and an outlet 31 whose passage surfaces 33, 34 extend at least substantially in parallel with one another and thereby define a straight-line main flow direction 35. The passage surfaces 33, 34 furthermore extend at least substantially in parallel with the exit surface 27 of the oxidation catalyst 20 and with the entry surface 29 of the reduction catalytic converter 21. The passage surfaces 33, 34, the exit surface 27 of the oxidation catalyst 20, and the entry surface 29 of the reduction catalytic converter 31 overlap one another and are preferably at least substantially congruent.

The oxidation catalyst 20, the reduction catalytic converter 21, and the apparatus 25 are integrated in a common housing 37 and substantially adjoin one another at least without a step. The connection of the housing 37 to the exhaust gas turbocharger 19 takes place via an inlet funnel 39. An outlet funnel 41 connects the housing 37 to the undersurface section 17 of the exhaust system 13.

The apparatus 25 for introducing and distributing a flowable reductant into the exhaust gas flow 46 comprises a flow conducting device 45 that leads the exhaust gas flow 46 exiting the oxidation catalyst 20 from the inlet 30 to the outlet 31.

A dividing apparatus 47, preferably composed of sheet metal and recognizable in FIGS. 3 and 4, is located in the region of the inlet 30 and defines two separate flow paths 48, 49 for respective part flows of the exhaust gas flow 46. As can be recognized in the schematic representation of FIG. 4, the flow paths 48, 49 are arranged in parallel with one another in a technical flow aspect. The division of the exhaust gas flow 46 into the two part flows is asymmetrical in the embodiment shown. The first flow path 48, the upper flow path 48 in FIG. 4, is specifically adapted for a considerably smaller part flow than the second flow path 49. An exemplary preferred division amounts to 95% mass flow to 5% mass flow. Other divisions of the mass flows are, however, also conceivable.

An injector 51 is provided in an entry section 50 of the first flow path 48 and is configured in a generally known manner for spraying a liquid reductant, in particular an aqueous urea solution, into the part flow of the first flow path 48. A mixing section 50 that extends at least substantially transversely to the main flow direction 35 is located downstream of the entry section 50.

In detail, the design of the flow conducting device 45 can be seen from the representations of FIGS. 3 to 8. It can in particular be seen from FIG. 6 that the mixing section 55 extends once through the total flow conducting device 45. The intake section 50 configured as a deflection section deflects the part flow of the first flow path 48 and generates an eddy thereof. The mixing section 55 opens into a deflection chamber 57.

The part flow of the second flow path 49 moves from the inlet 30 into a swirl generating section 59 (FIGS. 7 and 8) that has two oppositely disposed and respectively outwardly curved wall sections 60. Due to this design, a double swirl 65 is formed in the swirl generating section 59 during the operation of the internal combustion engine 11, as can be seen in FIG. 9. The respective swirl axes 66 are preferably arranged in parallel with one another and at right angles to the main flow direction 35.

The swirl generating section 59 has an inlet surface 67 (FIG. 9) that extends substantially in parallel with the passage surface 33 of the intake 30. The swirl generating section 59 furthermore has an outlet surface 69 (FIG. 6) that extends substantially at a right angle to the passage surface 34 of the outlet 31. This means that the part flow of the first flow path 48 is first deflected such that it flows transversely to the main flow direction 35. Exhaust gas exiting the swirl generating section 59 is in turn deflected before reaching the outlet 31 such that it flows in the main flow direction 35.

The deflection chamber 57 deflects the part flow exiting the mixing section 55 in U shape and supplies it to an elongate gas exit passage 71 (FIGS. 6 to 9) that extends transversely to the main flow direction 35 and is in flow communication with the swirl generating section 59 through a likewise elongate exit opening 75 (FIG. 7). With respect to the flow guidance, the mixing section 55 and the gas exit passage 71 extend at least substantially in opposite directions (FIG. 6).

A guide element 77 composed of sheet metal and arranged in the swirl generating section 59 can be recognized in FIGS. 7 and 9 and deflects exhaust gas passing through the exit opening 75 in the direction of the curved wall sections and thus supports the formation of the double swirl. The guide element 77 can have a sectionally U-shaped or V-shaped cross-section. It can also be seen from FIG. 9 that a flange 80 is provided in the region of the inlet 30. It is molded to the dividing apparatus 47 here.

As can be recognized in FIG. 6, the mixing section 55 is guided laterally around the swirl generating section 59 so that it is heated by it in operation. The egress surface 69 of the swirl generating section 59 is furthermore arranged such that the exhaust gas exiting the swirl generating section 59 acts on the entry section 50 from the outside. Fluid deposits are thus countered.

In FIGS. 10 to 12, the flow progression within the flow conducting device 45 is shown in simplified form, with respective individual components being omitted for illustration. Eddies arise in both the mixing section 55 and in the gas exit passage 71, as is illustrated by wavy lines. An eddy and/or a swirl is/are also formed in the deflection chamber 57.

The exhaust gas flow 46 exiting the oxidation catalyst 20 during the operation of the internal combustion engine 11 is therefore divided into two part flows of different amounts. The smaller part flow is deflected and moves to the injector 51 that sprays in the liquid reductant. The latter mixes with the part flow and evaporators to a large extent. The smaller part flow as a consequence has a relatively high concentration of reductant. The larger part flow moves into the swirl generating section 59 without the addition of reductant and is likewise deflected. An effective mixing of the already pre-mixed reductant in the main flow takes place on the merging of the two part flows in the region of the double swirl 56. A particularly homogeneous mixture is thus present at the outlet 31 and the substrate of the reduction catalytic converter 21 is subsequently acted on by it.

Since both part flows are deflected and in addition the smaller part flow is led around the larger part flow in a bypass arrangement, a relatively long mixing distance and a relatively large evaporator surface results despite the compact, substantially coaxial arrangement.

### REFERENCE NUMERAL LIST

11 internal combustion engine
13 exhaust gas system
15 section close to the engine
17 undersurface section
19 exhaust gas turbocharger
20 oxidation catalyst
21 reduction catalytic converter
25 apparatus for introducing and distributing a flowable reductant in an exhaust gas flow
27 exit surface of the oxidation catalyst
29 entry surface of the reduction catalytic converter
30 inlet
31 outlet
33 passage surface
34 passage surface
35 main flow direction
37 housing
39 inlet funnel
40 outlet funnel
45 flow conducting device
46 exhaust gas flow
49 dividing apparatus
48 first flow path
49 second flow path
50 entry section
51 injector
55 mixing section
57 deflection chamber
59 swirl generating section
60 curved wall section
65 double swirl
66 swirl axis
67 intake surface of the swirl generating section
69 egress surface of the swirl generating section
71 gas exit passage
75 exit opening
77 guide element
80 flange

1. An apparatus for introducing and distributing a flowable additive into an exhaust gas flow, the apparatus comprising:
an inlet to receive the exhaust gas flow from a first exhaust gas treatment device,
an outlet to output the exhaust gas flow to a second exhaust gas treatment device,
a flow conducting device to lead the exhaust gas flow from the inlet to the outlet, and
an injector opening into the flow conducting device,
wherein an at least substantially straight-line main flow direction of the apparatus is defined by the inlet and the outlet; and wherein a mixing section of the flow conducting device arranged downstream of the injector extends obliquely or transversely to the main flow direction.

2. The apparatus in accordance with claim 1,
wherein the inlet and the outlet have respective passage surfaces that extend at least substantially in parallel with one another and/or that at least regionally overlap in the main flow direction.

3. The apparatus in accordance with claim 1,
wherein the mixing section extends in an angular range between 30° and 150° with respect to the main flow direction.

4. The apparatus in accordance with claim 1,
wherein the flow conducting device has a deflection section arranged upstream of the mixing section for deflecting the exhaust gas flow and/or for generating an eddy of the exhaust gas flow in the mixing section.

5. An apparatus for introducing and distributing a flowable additive into an exhaust gas flow, the apparatus comprising:
an inlet to receive the exhaust gas flow from a first exhaust gas treatment device,
an outlet to output the exhaust gas flow to a second exhaust gas treatment device,
a flow conducting device to lead the exhaust gas flow from the inlet to the outlet, and
an injector opening into the flow conducting device,
wherein an at least substantially straight-line main flow direction of the apparatus is defined by the inlet and the outlet; wherein a mixing device of the flow conducting device is arranged downstream of the injector, and
wherein the flow conducting device defines a first flow path comprising the mixing section for a first part flow of the exhaust gas flow and a separate second flow path for a second part flow of the exhaust gas flow, with the first and second flow paths being arranged in parallel with one another in a technical flow aspect.

6. The apparatus in accordance with claim 5,
wherein the injector opens into the first flow path.

7. The apparatus in accordance with claim 5,
wherein the second flow path is adapted for a larger part flow than the first flow path.

8. The apparatus in accordance with claim 5,
wherein the second flow path comprises a swirl generating section that generates a swirl in the respective part flow during operation of the apparatus due to its shape.

9. The apparatus in accordance with claim 8,
wherein the swirl generating section is configured for generating at least one swirl whose swirl axis is arranged obliquely or transversely to the main flow direction.

10. The apparatus in accordance with claim 8,
wherein the swirl generating section has at least one curved wall section.

11. The apparatus in accordance with claim 8,
wherein the mixing section opens into a deflection chamber that deflects the part flow exiting the mixing section and supplies it to a gas exit passage that is in flow communication with the swirl generating section.

12. The apparatus in accordance with claim 11,
wherein the deflection chamber effects an at least substantially U-shaped deflection; and/or wherein the mixing section and the gas exit passage extend at least substantially in opposite directions.

13. The apparatus in accordance with claim 11,
wherein the gas exit passage is in flow communication with the swirl generating section at least through an exit opening.

14. The apparatus in accordance with claim 13,
wherein a guide element is arranged in the swirl generating section and deflects the exhaust gas exiting through the exit opening in the direction of a wall of the swirl generating section.

15. The apparatus in accordance with claim 14,
wherein the guide element has a U-shaped or V-shaped cross-section or a combination thereof.

16. The apparatus in accordance with claim 8,
wherein the mixing section is at least sectionally led around the swirl generating section.

17. The apparatus in accordance with claim 8,
wherein the swirl generating section has an intake whose intake surface extends at least substantially in parallel with a passage surface of the inlet; and/or wherein the swirl generating section has an egress whose egress surface extends at least substantially obliquely to a passage surface of the outlet.

18. The apparatus in accordance with claim 8,
wherein the swirl generating section has an egress that is arranged such that exhaust gas exiting it acts on at least one section of the first flow path.

19. The apparatus in accordance with claim 8,
wherein the swirl generating section has an egress that is arranged such that exhaust gas exiting it is deflected by at least 20° before reaching the outlet.

20. An exhaust gas system having:
a first exhaust gas treatment device,
a second exhaust gas treatment device, and
an apparatus for introducing and distributing a flowable additive into an exhaust gas flow led from the first exhaust gas treatment device to the second exhaust gas treatment device,
wherein the apparatus for introducing and distributing the flowable additive is arranged between the first and second exhaust gas treatment devices and the apparatus comprises
an inlet to receive the exhaust gas flow from a first exhaust gas treatment device,
an outlet to output the exhaust gas flow to a second exhaust gas treatment device,
a flow conducting device to lead the exhaust gas flow from the inlet to the outlet, and
an injector opening into the flow conducting device,
wherein an at least substantially straight-line main flow direction of the apparatus is defined by the inlet and the outlet; and
wherein a mixing section of the flow conducting device arranged downstream of the injector extends obliquely or transversely to the main flow direction; and/or
wherein a mixing device of the flow conducting device is arranged downstream of the injector, and wherein the flow conducting device defines a first flow path comprising the mixing section for a first part flow of the exhaust gas flow and a separate second flow path for a second part flow of the exhaust gas flow, with the first and second flow paths being arranged in parallel with one another in a technical flow aspect.

21. The exhaust gas system in accordance with claim 20,
wherein the first exhaust gas treatment device, the second exhaust gas treatment device, and the apparatus for introducing and distributing the flowable additive are integrated in a common, single-piece or multi-piece, housing and/or at least substantially adjoin one another without a step.

22. The exhaust gas system in accordance with claim 21,
wherein an egress surface of the first exhaust gas treatment device and an entry surface of the second exhaust gas treatment device extend at least substantially in parallel with one another and/or overlap at least regionally viewed in a straight-line main flow direction.
